(19) United States
(12) Patent Application Publication
(10) Pub. No.: US 2009/0281778 A1
(43) Pub. Date: Nov. 12, 2009

(54) METHOD AND SYSTEM FOR IDENTIFYING WEAK POINTS IN AN INTEGRATED CIRCUIT DESIGN

(75) Inventor: Jerome Belledent, Crolles (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/519,926

(22) PCT Filed: Dec. 10, 2007
(86) PCT No.: PCT/IB07/54993

§ 371 Date: Jun. 18, 2009

(30) Foreign Application Priority Data
Dec. 21, 2006 (EP) 06292035.0
Dec. 10, 2007 (IB) PCT/IB2007/054993

(51) Int. Cl. G06G 7/48

(52) U.S. Cl. 703/6

(57) ABSTRACT

A method for identifying weak points in the geometry of an integrated circuit, and the critical process condition at which the weak point is likely to fail. The simulation means of the OPC process is used to generate the simulated wafer structure, not only in ideal process conditions, but also at other, non-ideal process conditions. The difference in aerial image intensity of the non-ideal simulations is indicative of the presence and extent of a weak point. The edge-placement error between the ideal simulation and the simulation in which a weak point has been identified is used to determine the location of the weak point in the design.

### FIELD OF THE INVENTION

This invention relates to a method and system for identifying weak points in an integrated circuit design, and the worst process conditions associated with those weak points and, more particularly, to such a method and system for use in developing a mask for use in a photolithographic semiconductor device fabrication process.

### BACKGROUND OF THE INVENTION

Photolithography or optical lithography is a process used in semiconductor fabrication to transfer a pattern from a photomask to the surface of a substrate. A cycle of a typical silicon lithography procedure would begin by depositing a layer of conductive metal several nanometers thick on the substrate. A layer of photoresist (a chemical that ‘hardens’ when exposed to light) is applied on top of the metal layer. A transparent plate with opaque areas printed on it, called a photomask, is placed between the source of illumination and the wafer, selectively exposing parts of the substrate to light. Then the photoresist is developed, in which areas of unhardened photoresist undergo a chemical change. After a hard-bake, subsequent chemical treatments etch away the conductor under the developed photoresist, and then etch away the hardened photoresist, leaving conductor exposed in the pattern of the original photomask.

Optical microlithography is the key technology used in VLSI circuit fabrication, due to the relative ease of transferring layout patterns to silicon by optical projection printing, its high throughput and its high yield. In recent years, improvements to lithography have continued to bring down device sizes, bearing in mind that the key benefit of miniaturization in this regard is smaller and faster circuits. However, at small dimensions, loss of image quality in optical lithography erodes design-to-wafer fidelity on silicon. Optical proximity correction (OPC) is a photolithography enhancement technique commonly used to compensate for image errors due to diffraction or process effects, so as to increase the achievable resolution and pattern transfer fidelity for IC manufacturing. The fundamental idea behind OPC is to modify the photomask itself in order to correct for non-idealities that occur during pattern transfer. More specifically, OPC is the process of modifying the polygons that are drawn by the designers to compensate for the non-ideal properties of the lithography process. Given the shapes desired on the wafer, the mask is modified to improve the reproduction of the critical geometry. This is done by dividing polygon edges into small segments and moving the segments around, and by adding additional small polygons to strategic locations in the layout. The addition of OPC features to the mask layout allows for tighter design rules and significantly improves process reliability and yield.

There are many different types of OPC algorithms, the two main classifications being rule-based and model-based. Each involves subdividing polygons into smaller shapes or edge segments (fragmentation), moving or adding to the shapes, performing a fast simulation to determine if the new locations are better, moving them somewhere else, and iteratively repeating this process. Model-based OPC is simpler in that various geometries are treated by different rules. Model-based OPC is more complex and involves simulation of various process effects. For example, International Patent Application No. WO2006041868A1 describes a system and method for analyzing a photomask geometry, modifying the geometry, performing a simulation of the predicted resultant geometry and iteratively repeating the modification and simulation steps until the predicted resultant geometry is determined to be satisfactory.

Variations in the exposure conditions can occur due to natural variations, such as resist topography. In this case, the actual resultant geometry can deviate quite significantly, at least in certain regions of the design, relative to that which would have resulted if the best process conditions had been present. Known OPC techniques tend to simulate the predicted resultant geometry at best process conditions only, i.e. no over- or under-exposure and no defocus. Thus, the resultant photomask pattern may not be robust enough to process such natural variations. Thus, referring to FIG. 1, although the resultant geometry A (at best process conditions) is quite satisfactory relative to the mask design, the resultant geometry B (due to a deviation from the best process conditions) is far from satisfactory. Post-OPC checks, such as ORC, can highlight the weak regions of the design, but repairing the defect remains a highly difficult matter once the OPC has been processed.

Another solution might be for the simulation operation of the above-described OPC process to involve generating a simulation of the predicted resultant geometry for each of a number of sets of process conditions after each photomask modification step, identifying the worst case, and performing the next modification step to account for the worst case. However, the run-time of the process would then be prohibitively long.

### SUMMARY OF THE INVENTION

It is therefore an object of the present invention to provide a method and system for effectively and relatively easily determining, during the OPC process, the location of weak portions of a critical geometry and the worst case process conditions associated therewith, so as to make the resultant design robust enough to deal natural variations in process conditions without significantly increasing the run-time or the computational burden of the OPC process.

It is preferred to provide a method of identifying a weak point in the geometry of an integrated circuit in respect of which a lithography mask is created and subsequently modified by means of an optical proximity (OPC) process, said OPC process including the step of performing a simulation of a lithographic process using said lithography mask at ideal process conditions, the method comprising the steps of:

performing simulations of said lithographic process using said mask at a plurality of process conditions other than said ideal process conditions; and

generating an aerial image, and calculating the respective aerial image intensity at a location therein, in respect of each of said simulations, wherein a difference in image intensity from that calculated in respect of the simulation at ideal process conditions indicates the presence of a weak point, and the simulation from which said image intensity is derived indicates the process conditions at which said weak point is most likely to fail;

selecting a simulation in which a weak point is indicated to be present; and

calculating the edge-placement error (EPE) between said selected simulation and said simulation performed at ideal process conditions, wherein the location at which the EPE is largest corresponds to the location of the weakest point in said geometry.

Thus, the method of the present invention provides a way of sensing the location of weak points and the process condition at which they fail by looking at how the aerial image intensity varies along the target edges while simulating different process conditions. The biggest variation in intensity from the nominal (ideal) condition corresponds to the most critical process condition. This step is fast enough to be relatively easily implemented in the OPC flow as it is only necessary to calculate the image intensity at one point per site. Another advantage of the method of the present invention is the fact that the result will always be independent of the modelling site orientation.

Once the method has been performed, a pattern can easily be strengthened by attaching the model simulating the worst process condition (or any intermediate condition) to the weak portion, as well as placing the site to the most critical location. Thus, the present invention extends to an optical proximity correction method, comprising identifying a weak point in the geometry of an integrated circuit, and the process condition at which it is most likely to fail, in accordance with a method defined above, and modifying a lithography mask at a location corresponding to said weak point, wherein said modification is performed to compensate for said weak point in the presence of the process condition at which said weak point is most likely to fail. Thus, the target is moved at the location of a weak point according to the type of defect detected. For example, if the pattern is likely to pinch at the location of the weak point, the target will be moved outward. Therefore, the behavior across the process window will give the new target that will be used to run the OPC based on a simulation under ideal conditions.

Process conditions may comprise any parameter that can be simulated, including one or more of focus, dose, mask critical dimension (CD), aberration change illumination shape, mash transmission variation, polarization change, etc. Further relevant process conditions will be apparent to a person skilled in the art. However, in a preferred exemplary embodiment, the process conditions correspond to exposure settings, i.e. radiation dose and focus, and the simulations are performed at one or more defocus conditions, one or more over- or under-exposure conditions and one or more combined (i.e. defocus and over- or under-exposure) conditions, as well as at the nominal condition comprising zero defocus and zero over- or under-exposure.

The simulation means may comprise any known simulation means used in conventional OPC systems, and the present invention is not necessarily intended to be limited in this regard. Equally, the manner in which the intensity is calculated can be the same modelling scheme as is used in OPC software packages, as will be apparent to a person skilled in the art. The idea is that for the target change calculation, the simulation does not have to be very accurate as it is compared to a reference matrix that has been calculated in the same way.

In one exemplary embodiment, the method comprises:

selecting the largest difference in image intensity relative to that at the nominal condition;

calculating the EPE between the simulation to which said largest difference in image intensity corresponds and the simulation at the nominal condition;

identifying the location of the largest EPE as the weakest point; and

recording the location in the geometry of the weakest point and the process condition at which said weakest point is most likely to fail.

The present invention extends further to a lithography mask for use in semiconductor fabrication, said mask defining the pattern of an integrated circuit to be transferred onto a substrate, wherein said mask is modified by means of an OPC method as defined above, and to an integrated circuit manufactured using said photolithography mask.

Also in accordance with the present invention, there is provided a system for identifying a weak point in the geometry of an integrated circuit in respect of which a lithography mask is created and subsequently modified by means of an optical proximity (OPC) system, said OPC system including simulation means for performing a simulation of a lithographic process using said lithography mask at ideal process conditions, the system comprising:

means for causing said simulation means of said OPC system to perform simulations of said lithographic process using said mask at a plurality of process conditions other than said ideal process conditions; and

means for generating an aerial image, and calculating the respective aerial image intensity at a location therein, in respect of each of said simulations, wherein a difference in image intensity from that calculated in respect of the simulation at ideal process conditions indicates the presence of a weak point, and the simulation from which said image intensity is derived indicates the process conditions at which said weak point is most likely to fail;

the system further comprising:

means for selecting a simulation in which a weak point is indicated to be present;

means for calculating the edge-placement error (EPE) between said selected simulation and said simulation performed at ideal process conditions, wherein the location at which the EPE is largest corresponds to the location of the weakest point in said geometry; and

means for identifying the location of a weak point from the edge-placement error.

The present invention extends to an OPC system including the system defined above.

The present invention also extends to a lithography mask for use in semiconductor fabrication, said mask defining the pattern of an integrated circuit to be transferred onto a substrate, wherein said mask is modified by means of an OPC system as defined above, and to an integrated circuit manufactured using said photolithography mask.

These and other aspects of the present invention will be apparent from, and elucidated with reference to, the embodiments described herein.

### BRIEF DESCRIPTION OF THE DRAWINGS

Embodiments of the present invention will now be described by way of examples only and with reference to the accompanying drawings, in which:

FIG. 1 is a schematic illustration of a portion of a required critical geometry, showing the resultant geometries at ideal process conditions and at worst process conditions;

FIG. 2 is a schematic block diagram illustrating a lithography simulation process for OPC;

FIG. 3 is a schematic block diagram illustrating the principal steps in a method according to an exemplary embodiment of the present invention;

FIG. 4 is a schematic illustration of a first example of the results of a method according to the present invention; and

FIG. 5 is a schematic illustration of a second example of the results of a method according to the present invention.

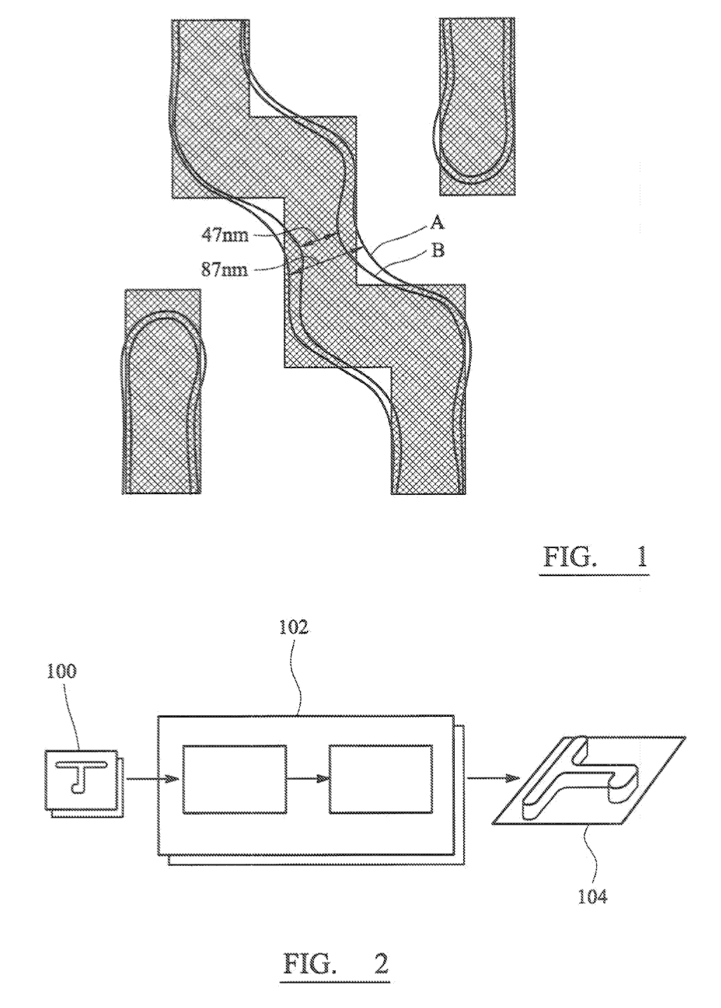

### DESCRIPTION OF THE EMBODIMENTS

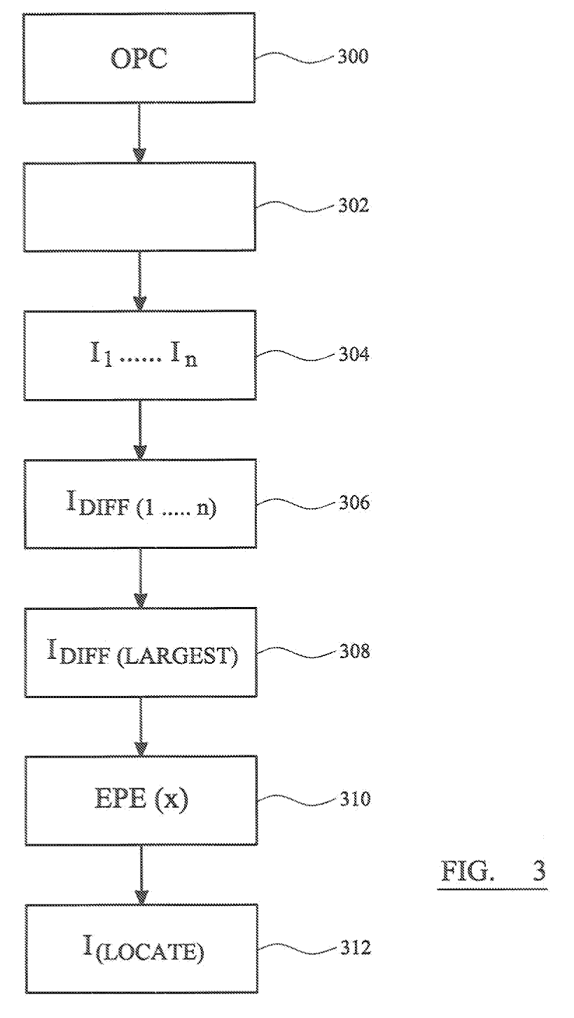

As explained above, and referring to FIG. 2 of the drawings, known OPC techniques include the use of a simulation model 102 which receives the latest version of the photomask 100 and outputs a three-dimensional simulation 104 of the predicted resultant geometry. The aerial image has long been used as a first order approximation to the final etched features produced by microlithography, and evaluation of aerial images using Hopkin's equation is also known. Hopkin's equation gives the intensity of aerial images reproduced on the wafer by convolving mask patterns with the light source and conventional OPC techniques perform intensity calculations in respect of a single exposure setting, i.e. ideal process conditions (or “nominal conditions”), for each simulation operation.

As explained above, however, it will be well known to a person skilled in the art that variations in radiation dose and focus relative to nominal conditions (=zero defocus and no over- or under-exposure) can have a significant adverse effect on critical dimension (CD) error. Nevertheless, such variations do occur because of factors such as resist topography and other natural variations, which photomask designs created by conventional OPC techniques are not robust enough to deal with.

The present invention can be used to alleviate the problems that might otherwise occur as a result of such variations. Referring to FIG. 3 of the drawings, in a method according to an exemplary embodiment of the present invention, in a first step 300, any known OPC technique may be performed in order to generate an optimum mask design in respect of a particular critical geometry. Thus, as in prior art schemes, a final simulated wafer structure is generated giving the predicted resultant design, but only for the ideal (or reference) process conditions (in this case, the exposure setting with no over- or under-exposure and no defocus). In addition, however, simulations of the wafer structure are also performed for a number of different exposure settings.

Next, at step 302, an aerial image is generated in respect of each of the simulations, i.e. that for the ideal process condition and those generated for the different exposure settings, in this case: +/−defocus only, over-/under-exposure only, under-exposure/+/−defocus, over-exposure/+/−defocus and, at step 304, the aerial image intensity (I₁ . . . Iₙ) is calculated at one point on the aerial image for each respective exposure setting. At step 306, the differences (I_{DIFF(1 . . . n)}) between the respective aerial image intensities at the various exposure settings (other than the nominal conditions) and that at the ideal process conditions are determined. At step 308, the most critical process conditions can be determined simply by identifying the process conditions that correspond to the biggest intensity difference (I_{DIFF(LARGEST)}) determined in the previous step. Finally, at step 310, the simulation at the worst process conditions is compared with that at the ideal process conditions and the edge-placement error (EPE) is calculated between the two:

EPE(x)=D(x)−W(x)

a parametric function of x, which is a dummy variable that can take values between 0 and 1. D and W refer to the intensities derived from the simulations at ideal process conditions and worst process conditions (and x is a dummy variable that is varied from 0 to 1 to move the EPE determination along the perimeter of the contours of the two simulations). Actually, for the purpose of the given equation, it does not matter which of D and W is assigned to the respective intensity, but for this embodiment, D is considered to relate to ideal process conditions and W is considered to relate to worst process conditions.

Varying x from 0 to 1 moves the determination along the perimeters of the contours of the two simulations. In other words, for the purpose of calculating the amount of EPE change across the process window, the intensity profiles are approximated at target by it's tangential plane and the distance from the target to the intersection of this latest plane where the threshold is used herein as the EPE. Although this is not an accurate indication of true EPE (using rigorous calculation, empirically proven on a full layout), this does not matter because the EPE at nominal process conditions is determined in the same way and the difference between the two values thus determined is fairly accurate when compared with the case where rigorous calculation is used. A significant advantage is that only a small number of simulations are required to calculate the tangential plane, as opposed to the 22 required in a conventional method.

Thus, the point on the design at which the EPE is the largest can be relatively easily identified (at step 312), which represents the weakest point (I_{LOCATE}) in the critical geometry. As a result it is possible to identify the weakest points in the critical geometry corresponding to the most critical processing conditions associated therewith.

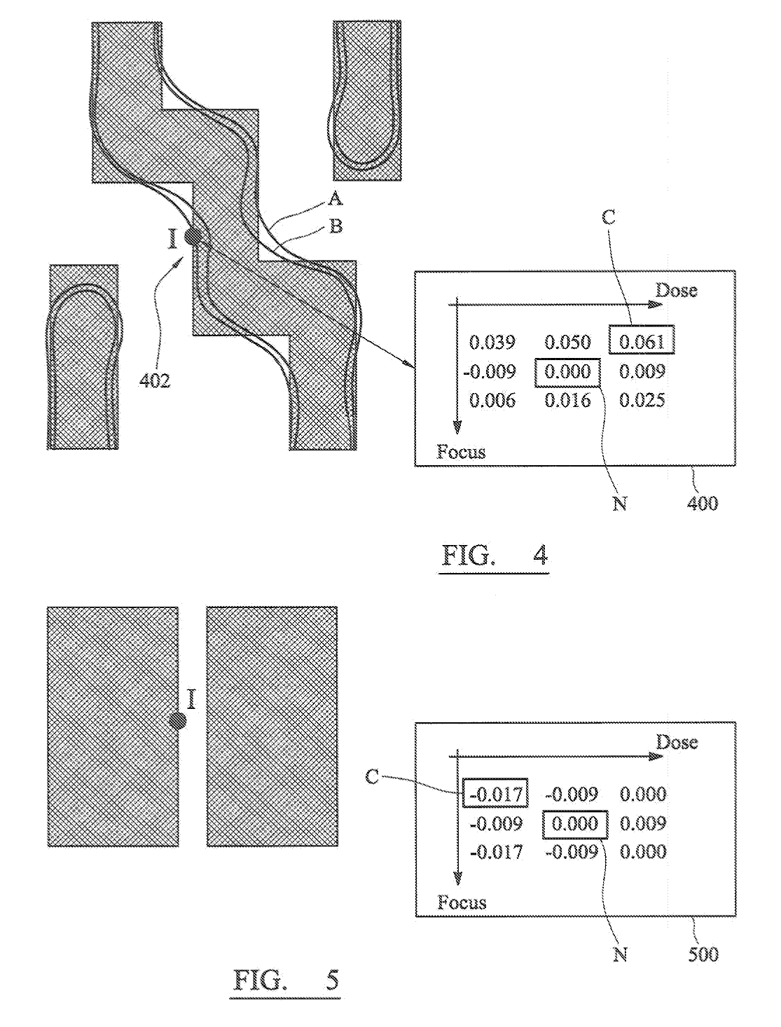

Referring to FIG. 4 of the drawings, by way of example, there is shown a structure 402 that is likely to pinch under certain process conditions. The differences in intensity of the various simulations relative to that at the nominal conditions (N) are illustrated in tabular form (400) and indicate that the greatest variation in intensity (i.e. at critical process conditions C) from nominal process conditions is found at point I with the exposure settings being over-exposure plus defocus. Referring to FIG. 5 of the drawings, by way of further example, there is illustrated the case of a structure that is likely to bridge under certain process conditions. The differences in intensity of the various simulations relative to that at the nominal conditions (N) are shown in tabular form (500) and indicate that the greatest variation in intensity (i.e. at critical process conditions C) from nominal process conditions is found at point I with the exposure settings being under-exposure plus defocus.

Once a weak point has been detected, the target in the OPC scheme is moved according to the type of defect detected. For example, if the pattern is likely to pinch at the weak point (as illustrated in FIG. 4), the target will be moved outward. If, on the other hand, the pattern is likely to bridge at the weak point (as illustrated in FIG. 5), the target will be moved inward. Thus, a new target is generated for use in running the OPC based on a simulation under ideal conditions.

It will be appreciated that the present invention is not primarily concerned with correcting the bridging and necking, which relate more to CD information (and require 2-edge simulation and complex measurement techniques). Instead, the present invention is concerned with correction such than the edge target meets specifications within a given process window. In consequence, large lines could also be corrected for pinching but it does not necessarily matter because the correction (measured in percentage of CD) will be satisfactory and will never exceed user specified limits anyway. Nevertheless, true pinching cases will always be corrected.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of identifying a weak point in the geometry of an integrated circuit in respect of which a lithography mask is created and subsequently modified by an optical proximity correction (OPC) process, said OPC process including the step of performing a simulation of a lithographic process using said lithography mask at ideal process conditions, the method comprising the steps of
performing simulations of said lithographic process using said mask at a plurality of process conditions other than said ideal process conditions; and
generating an aerial image, and calculating the respective aerial image intensity at a location therein, in respect of each of said simulations, wherein a difference in image intensity from that calculated in respect of the simulation at ideal process conditions indicates the presence of a weak point, and the simulation from which said image intensity is derived indicates the process conditions at which said weak point is most likely to fail;
selecting a simulation in which a weak point is indicated to be present; and
calculating the edge-placement error (EPE) between said selected simulation and said simulation performed at ideal process conditions, wherein the location at which the EPE is largest corresponds to the location of the weakest point in said geometry.

2. A method according to claim 1,
wherein said conditions correspond to exposure settings, and
wherein said plurality of process conditions other than said ideal process conditions include some of one or more defocus conditions, one or more over- or under-exposure conditions or a combination, thereof
wherein said ideal process conditions comprise zero defocus and zero over- or under-exposure.

3. A method according to claim 1, comprising:
selecting the largest difference in image intensity relative to that at the nominal condition;
calculating the EPE between the simulation to which said largest difference in image intensity corresponds and the simulation at the nominal condition;
identifying the location of the largest EPE as the weakest point; and
recording the location in the geometry of the weakest point and the process condition at which said weakest point is most likely to fail.

4. An optical proximity correction method, comprising identifying a weak point in the geometry of an integrated circuit, and the process condition at which it is most likely to fail, in accordance with the method of claim 1, and modifying a lithography mask at a location corresponding to said weak point, wherein said modification is performed to compensate for said weak point in the presence of the process condition at which said weak point is most likely to fail.

5. A lithography mask for use in semiconductor fabrication, said mask defining the pattern of an integrated circuit to be transferred onto a substrate, wherein said mask is modified by means of an OPC method according to claim 4.

6. An integrated circuit manufactured using the photolithography mask of claim 5.

7. A system for identifying a weak point in the geometry of an integrated circuit in respect of which a lithography mask is created and subsequently modified by means of an optical proximity (OPC) system, said OPC system including simulation means for performing a simulation of a lithographic process using said lithography mask at ideal process conditions, the system comprising:
means for causing said simulation means of said OPC system to perform simulations of said lithographic process using said mask at a plurality of process conditions other than said ideal process conditions; and
means for generating an aerial image, and calculating the respective aerial image intensity at a location therein, in respect of each of said simulations, wherein a difference in image intensity from that calculated in respect of the simulation at ideal process conditions indicates the presence of a weak point, and the simulation from which said image intensity is derived indicates the process conditions at which said weak point is most likely to fail;
the system further comprising:
means for selecting a simulation in which a weak point is indicated to be present;
means for calculating the edge-placement error (EPE) between said selected simulation and said simulation performed at ideal process conditions, wherein the location at which the EPE is largest corresponds to the location of the weakest point in said geometry; and
means for identifying the location of a weak point from the edge-placement error.

8. An OPC system including the system defined according to claim 7.

9. A lithography mask for use in semiconductor fabrication, said mask defining the pattern of an integrated circuit to be transferred onto a substrate, wherein said mask is modified by means of an OPC system according to claim 8.

10. An integrated circuit manufactured using the photolithography mask of claim 9.
